(19) United States
(12) Patent Application Publication
(10) Pub. No.: US 2023/0184296 A1
(43) Pub. Date: Jun. 15, 2023

(54) HALF SHAFT WITH DOUBLE STUB END

(71) Applicant: KAI-PETER BERNDT, LAS VEGAS, NV (US)

(72) Inventor: KAI-PETER BERNDT, LAS VEGAS, NV (US)

(21) Appl. No.: 17/547,674

(22) Filed: Dec. 10, 2021

(51) Int. Cl. F16D 3/22; F16D 3/84

(52) U.S. Cl. CPC F16D 3/22; F16D 3/845; F16D 3/202; F16D 2250/0023; F16D 2250/0069

(57) ABSTRACT

The claimed invention is directed to a novel composite half shaft. More specifically, the claimed invention provides for the integration of a continuous velocity joint within the hollow tubular portion of the axle shaft, which permits for a longer lightweight composite hollow shaft. The use of the lightweight material over additional length results in an overall weight reduction. Additional benefits include reduced unsprung weight in vehicles, improved mileage for gas powered vehicles and increased range for electric vehicles. The use of composite materials in place of a solid or hollow metal axle bar results in improved noise, vibration and harshness (“NVH”) characteristics over conventional half shafts..

### FIELD OF THE INVENTION

The claimed invention relates to vehicle powertrains and drivetrains. More particularly, the claimed invention relates to a lightweight half shaft with an innovative double stub end.

### BACKGROUND OF THE INVENTION

As is well-known in the art, a half-shaft is a drive axle that extends from either a transaxle or a differential to one of the wheels. Conventional half shafts designs have a heavy bearing located at each end of a solid or hollow axle bar in the middle of the assembly. This results in very heavy assemblies. Efforts have been made to reduce the weight of half shafts in the past. One well known effort simply replaces the solid or hollow axle bar with a hollow composite section. While this substitution does reduce the overall weight of a half shaft, the weight savings are overshadowed by the increased cost of the composite half shaft and complexity of producing the composite half shaft. What is needed is a solution that reduces the overall weight of the half shaft assembly, while maintaining the required strength and functionality of the half shaft.

### SUMMARY OF THE INVENTION

The claimed invention is directed to a composite half shaft. More specifically, the claimed invention provides for the integration of a continuous velocity joint within the hollow tube portion of the axle shaft, which permits for a longer lightweight composite hollow shaft. The use of the lightweight material over additional length results in an overall weight reduction and a commercially feasible composite half shaft. Benefits of the claimed invention include reduced unsprung weight in vehicles which improves the ride quality of the vehicle. Additionally, the reduced weight of the claimed invention improves mileage for gas powered vehicles and increases range for electric vehicles. Moreover, the use of composite materials in place of a solid or hollow metal axle bar results in improved Noise, Vibration and Harshness (“NVH”) characteristics of the vehicle overall.

### BRIEF DESCRIPTION OF THE DRAWINGS

FIG. 1 shows a side elevational view of a conventional half shaft assembly commonly used in the automotive industry

FIG. 2 shows a side elevational view of the bearing assembly in a conventional half shaft as is known in the art.

FIG. 3 shows a side elevational view of a conventional axle bar and its stub end sections.

FIG. 4 shows a schematic view of a common vehicle driveline for a four wheel drive vehicle.

FIG. 5 shows a side elevational view of a conventional composite half shaft assembly known in the art.

FIG. 6 shows a section view of the conventional composite half shaft assembly shown in FIG. 5

FIG. 7 shows a section view of the continuous velocity joint components of the composite half shaft showin in FIG. 5.

FIG. 8 shows a section view of one embodiment using an adhesive to attach the continuous velocity joint into the composite half shaft show in FIG. 5.

FIG. 9 shows a section view of one embodiment using a press fit to join the continuous velocity joint into the composite half shaft shown in FIG. 5.

FIG. 10 shows a side elevational view of the claimed composite half shaft.

FIG. 11 shows a section view of the claimed composite half shaft shown in FIG. 10.

FIG. 12 shows a side view of the double stub end used in the constant velocity joint assemblies used on each end of the claimed composite half shaft.

FIG. 13 shows a section view of the claimed composite half shaft wherein an adhesive is used to secure the continuous velocity joint to the composite shaft.

FIG. 14 shows a section view of the claimed invention wherein the constant velocity joint is press fit into the composite shaft.

### DETAILED DESCRIPTION

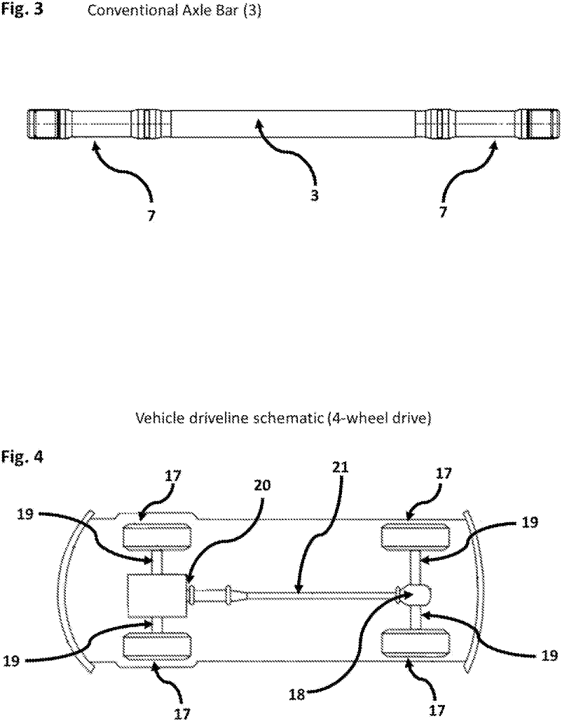

Referring now to the drawings in detail, wherein like reference letters and numbers refer to like elements throughout, FIG. 4 shows a basic schematic drawing of a four-wheel drive vehicle comprising a motor or transaxle [20] with a half shaft [19] powering a wheel on either side of the motor or transaxle [20] and a driveshaft [21] powering a rear differential [18]. If not connected to motor [20], rear differential could be replaced by a motor. Half shafts [19] on each side of motor [20] or rear differential [18] power wheels [17].

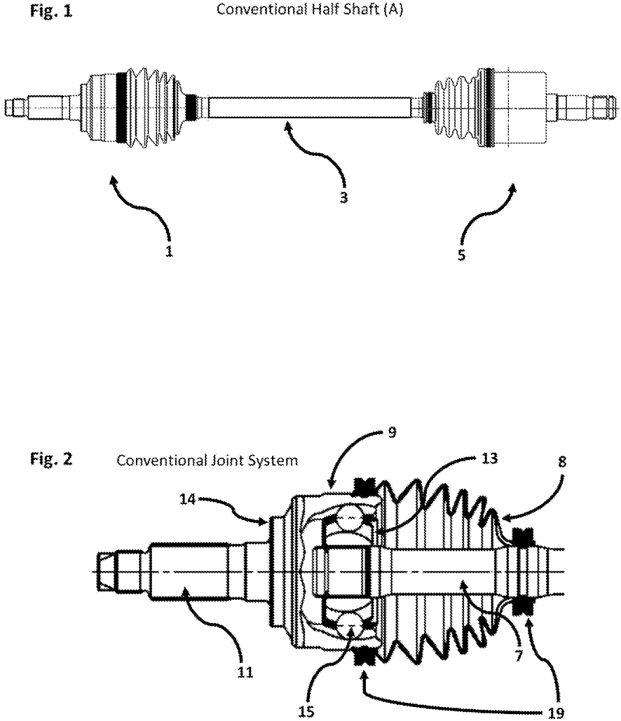

As shown in FIG. 1, a conventional half-shaft assembly (A) consists of an outer joint [1], an axle bar [3] and an inner joint [5]. The axle bar [3] has stub ends [7] on each side, shown in FIG. 2 and FIG. 3. Referring now to FIG. 2, each of the inner joint [5] and the outer joint [1] system consists of conventional continuous velocity (“CV”) joints comprising bearing assemblies, that is, an outer race [9] with a connected stub end [11], a number of balls [15] and an inner race [13] which connects via a splined tooth profile on the mating components to a stub end [7] to transmit torque in a flexible way. Alternatively, tripod joints, (not shown) could be substituted for the CV joint. The overall joint system is lubricated with a specified grease and sealed off with a flexible rubber boot [8]. To keep the rubber boot [8] in place it is secured by metal clamps [19] at each end.

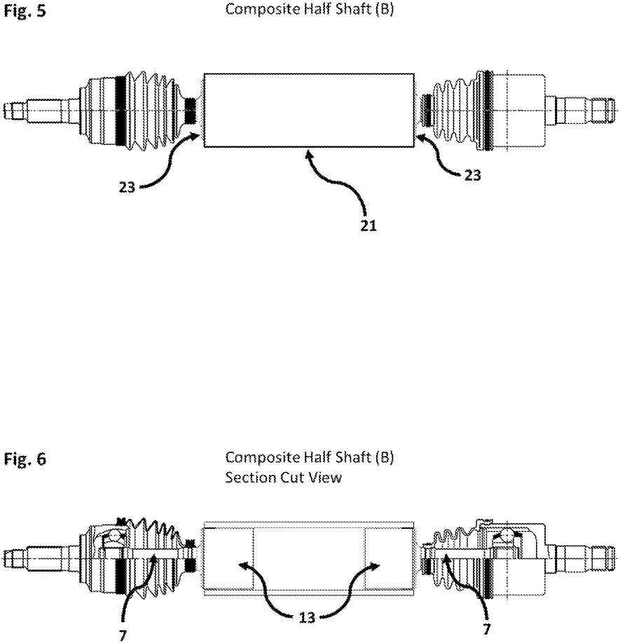

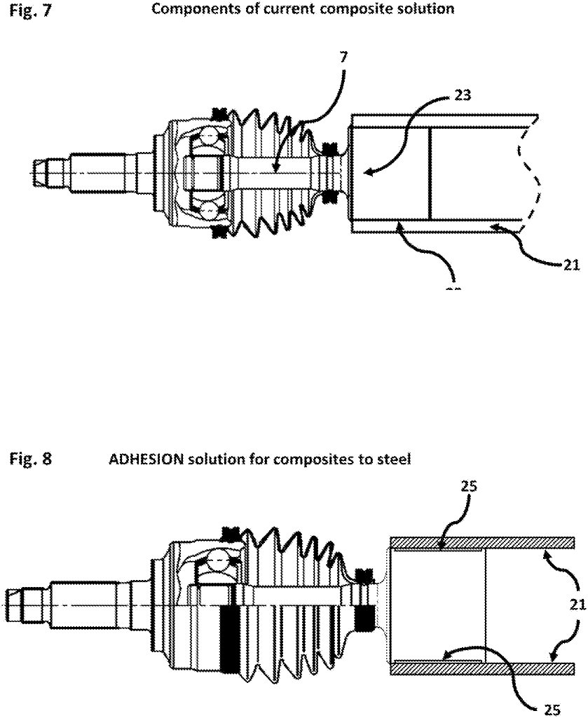

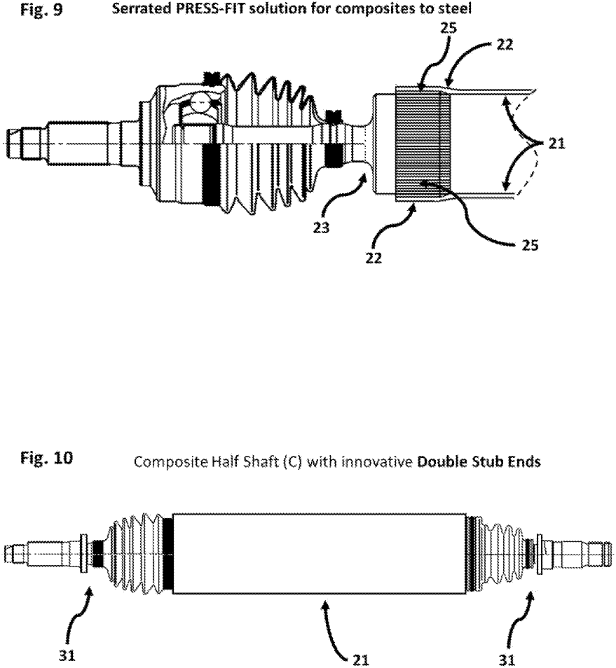

As indicated above, attempts have been made to reduce the weight of existing half shafts. One such example is shown in in FIG. 5. As shown in FIG. 5, a typical composite version of a half-shaft (B) according to simply replaces the axle bar [3] with its according stub ends [7] with a combination of a composite tube [21], an adapter piece [23] with stubs ends [7] at each end of the composite tube [21] which are visible on the section view of FIG. 6 on each tube end, which then connect to a wheel [17] on one end and a motor [20], differential or transaxle [18] on the other end. As shown in more detail in FIG. 7, the use of composite tube [21] in the place of the axle bar [3] requires some significant adaptation. In the example embodiments shown, the adapter pieces [23] with stub ends [7] can be either pressed in or glued in by adhesives at the press-fit or adhesion area [25] to connect to the composite tube [21] and transmit torque. If the adhesives are used, the adhesion version typically utilizes a defined gap by design between the composite tube [21] and the adapter [23] to allow for proper enclosure of injected adhesives in order to bond the composite with steel components as shown in more detail in FIG. 8. Now referring to FIG. 9, which shows a press fit version of the half shaft shown in FIG. 8. The press fit version typically utilizes a serration / specific tooth profile on the adapter piece [23], which then gets pressed into the composite tube [21] with interference between the two components. The composite tube [21] then typically is equipped with a support ring section [22] with an increased diameter of the carbon fiber wall thickness to withstand the press forces during the assembly process and transmit torsional loads during operation. This serrated press-fit creates a form lock and is typically capable of handling higher torque loads on the one hand and longer life cycles / durability on the other hand than the adhesion version.

As shown in both FIGS. 8 and 9, the remainder of the assembly stays identical to the standard/conventional half-shaft assembly (A) shown in FIG. 1. Among the challenges of the existing composite half shaft design is that the weight savings achieved using the composite tube [21] are replaced by the weight of the adapter pieces [23] which are generally quite large and heavy metal pieces.

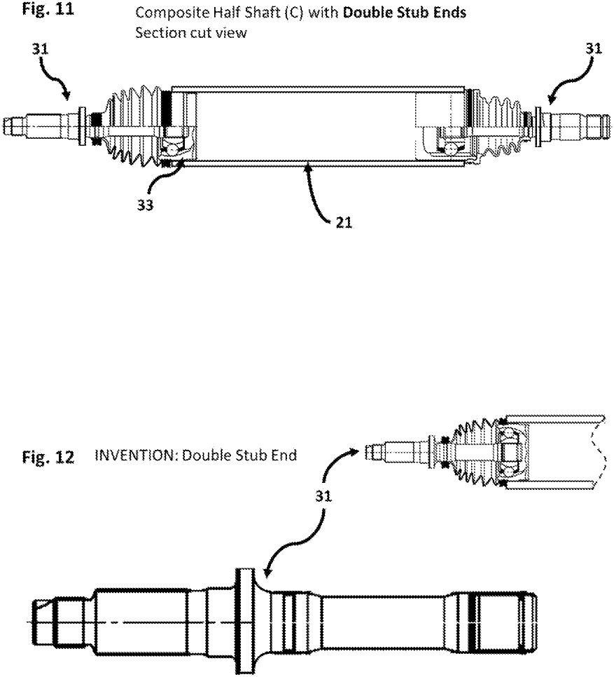

Now referring to FIG. 10, which shows a side view of the claimed composite half shaft. As can be seen in FIG. 10, the claimed invention permits a more extensive use of lighter composite material in comparison with the design shown in FIG. 6, thereby leading to significant weight savings. Additionally, as can be seen more clearly in FIG. 11, no adapter pieces [23] are required. The claimed invention further includes the use of a double stub-end [31] as shown in FIG. 12. Referring now to FIG. 11, the claimed composite half shaft tube [21] allows for an inclusion of the joint system into the inside of a half shaft composite tube as shown in FIG. 10 while offering additional weight savings compared to existing concepts of lightweight half shafts.

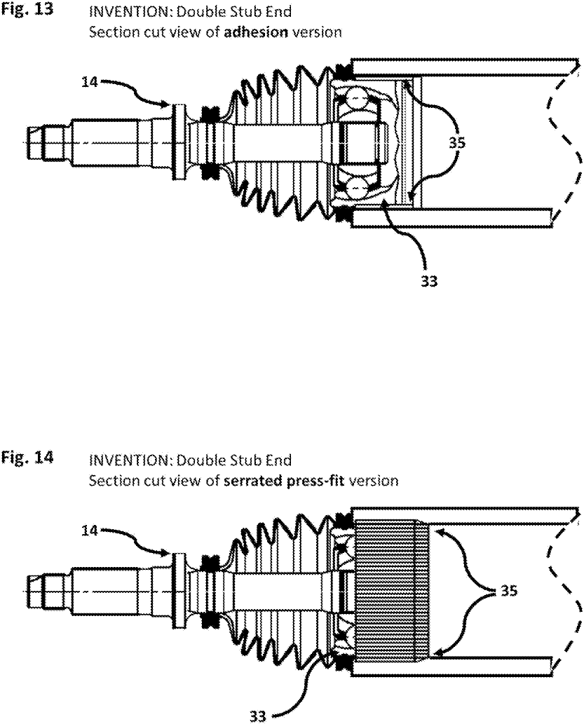

Notably, the use of the double stub end [31] allows for the adapter piece [23] to be eliminated, as the outer race [33] of the continuous velocity joint serves as the metal surface for a press-fit or adhesion area [35] shown in FIG. 13 & FIG. 14. Notably, the claimed invention can also employ the use of a tripod joint (not shown) at either end. In the case of a use of a tripod joint, the outer portion of the tripod joint housing is press fit or adhered to the inner portion of the composite half shaft tube [21]. The claimed design therefore allows for further weight reductions in the shoulder area [14], as the transition material from stub end to cv-joint can be reduced and only a minimal shoulder feature is required to stay for assembly in the wheel hub and/or transmission output shaft. The use of the double stub end [31], which has not been realized in the automotive or industrial market permits a commercially feasible carbon fiber half shaft.

In application, a composite half shaft assembly may comprise a hollow tubular composite axle having an inner wall and an outer wall and having a power input end and a power output end; a power input constant velocity joint comprising a power input bearing, the power input bearing comprising an inner race and an outer race, the exterior of the outer race being secured to the inner wall of the hollow tubular composite axle at the power input end; a power input double stub end having a first end secured to the inner race of the power input bearing and a second end protruding from the power input end of the hollow tubular composite axle; a power output constant velocity joint comprising a power output bearing, the power output bearing comprising an inner race and an outer race, the exterior of the outer race being secured to the inner wall of the hollow tubular composite axle at the power output end; and a power output double stub end having a first end secured to the inner race of the power output bearing and a second end protruding from the power output end of the hollow tubular axle. In some embodiments, the composite half shaft may further comprise a flexible rubber boot, the rubber boot being attached at a first end around the power input end of the tubular composite axle and at the second end around the power input double stub end. Additionally, at least one of the power input constant velocity joint or the power output constant velocity joint can be press fit into the inner wall of the hollow tubular composite axle. As opposed to a press fit, it is also possible that at least one of the power input constant velocity joint or the power output constant velocity joint is secured to the inner wall of the hollow tubular composite axle with an adhesive. In application, it should be noted that each of the power input constant velocity joint and the power output constant velocity joints are situated within the inner wall of the hollow tubular composite axle. Finally, it must be noted that the claimed invention could also employ a tripod joint in place of the CJ joint.

### INDUSTRY APPLICATION

The proposed invention can be applied in multiple markets, e.g. automotive passenger vehicles of all kinds (Sedan, SUV, Sports Car, Pick-Up Trucks, etc.), light duty trucks, industrial applications (e.g. electric power generation, conveyer systems, food processing, paper mills, etc.) as well as aviation, aerospace and military applications. The biggest positive impacts of this invention would be noticeable in Electric Vehicles (EVs) due to the combination of benefits which are elaborated below.

There are a variety of benefits that come with the proposed solution for a light weight composite half shaft with a weight optimized double stub end solution and the following paragraphs will describe each aspect individually. The main benefit is clearly the weight savings which account for 12% to 20% of a full assembly of half shafts. This could account for between five and seven (5-7) pounds of weight savings for a two-wheel drive vehicle and more than ten (10) pounds of weight savings on a four-wheel drive vehicle. A first physical prototype of a General Motors Acadia/Traverse rear half shaft has shown 16% weight reduction compared to the original equipment half shaft. A second physical prototype of a Tesla Model 3 rear half shaft has shown 12% weight reduction compared to the original equipment half shaft. If an original equipped half shaft is combined with an additional vibration damper, the weight saving can reach 20% or more.

The aforementioned weight savings result also in reduced rotational mass to move, as well as in a reduced amount of un-sprung mass in the vehicle’s chassis system which improves responsiveness in the suspension system in order to keep the best possible ground contact between tire and road.

An additional benefit using a direct application of a composite half shaft is in the area of NVH management in a vehicle. Composites have a natural characteristic of dampening mechanically generated noise, vibrations and impact transmission due to the material properties of composite structures and components. The three areas of NVH and the benefits of utilizing weight optimized composite half shafts are described and explained below.

When we talk and think about noise in a vehicle, we are referring to sound that is being generated by other components & interactions and how this sound is being transmitted throughout the vehicle. Composite and especially carbon fiber reinforced plastics (CFRP) have superior materials properties in regards to sound absorption and vibration damping compared to any metal components. In fact, some metal structures within a vehicle can amplify the perceived sound of specific sources due to their own natural frequencies. The desired frequency for each composite application and operation, especially for driveline components, can be achieved by engineering and altering the composite layer structure individually.

When we look at vibration control in a vehicle, we try to understand where a physically perceivable vibration comes from and how it is transmitted through the vehicle, in a very similar way to how we analyze noise. An example of this is the event of a “wheel hop”, where the tire loses contact to the ground during acceleration and finds grip again. Conventional steel half shafts are required to have a fairly low torsional stiffness to partially compensate for this problem but it doesn’t ever fully go away. Composite half shafts have 5 to 10 times the torsional damping characteristics of steel shafts. This critical damping characteristic can be adjusted to each applications requirement whereas steel shafts are bound and limited to their material properties.

When we refer to harshness, we refer to the mechanical impact outside factors can have on the life expectancy of systems, sub-systems and components. One great example of this is “gear pitting” - which described small dents in the teeth of mechanical gears like we find them in differential units and transmissions. Certain road conditions, for example “wheel hop”, can cause high peak loads and shock loads in the driveline which lead gears not to roll off one another but rather hit each other back and forth. These hits leave marks in the gears and reduce the life time of the components as wear in between gears increases. The dampening characteristics of composite shafts can significantly reduce the amount of gear pitting in a transmission, transfer case or differential unit and therefore increase the life expectancy of systems and reduce maintenance costs.

Electric vehicles can benefit significantly from the use of composite half shafts, since EVs don’t need half shafts with low torsional stiffness to cover up vibrations from the powertrain (nonuniform excitement caused by cranktrain of internal combustion engines). In fact, half shafts with a high stiffness in EVs can create better responsiveness of the vehicle and enhance the driving dynamics. It has even been proven that composite half shafts with high torsional stiffness improves wheel hop behavior in EVs.

The claimed composite half shaft now enables a more streamlined, efficient and cost-effective manufacturing of composite half shafts, since it eliminates unnecessary components and leverages the use of composites and weight optimized steel components to a maximum level.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A composite half shaft comprising:
a hollow tubular composite axle having an inner wall;
a constant velocity joint comprising a bearing, the bearing comprising an inner race and an outer race, the exterior of the outer race being secured to the inner wall of the hollow tubular composite axle; and
a double stub end having at least a first end secured to the inner race of the bearing and a second end protruding from the hollow tubular composite axle.

2. The composite half shaft of claim 1 further comprising a flexible rubber boot, the rubber boot being attached at a first end around the tubular composite axle or constant velocity joint and at the second end around the double stub end.

3. The composite half shaft of claim 1 wherein the constant velocity joint is press fit into the inner wall of the hollow tubular composite axle.

4. The composite half shaft of claim 1 wherein the constant velocity joint is secured to the inner wall of the hollow tubular composite axle with an adhesive.

5. The composite half shaft of claim 1 wherein the constant velocity joint is situated almost entirely within the inner wall of the hollow tubular composite axle.

6. The composite half shaft of claim 1 wherein the constant velocity joint is a tripod joint.

7. A composite half shaft assembly comprising:
a hollow tubular composite axle having an inner wall and an outer wall and having a power input end and a power output end;
a power input constant velocity joint comprising a power input bearing, the power input bearing comprising an inner race and an outer race, the exterior of the outer race being secured to the inner wall of the hollow tubular composite axle at the power input end;
a power input double stub end having a first end secured to the inner race of the power input bearing and a second end protruding from the power input end of the hollow tubular composite axle;
a power output constant velocity joint comprising a power output bearing, the power output bearing comprising an inner race and an outer race, the exterior of the outer race being secured to the inner wall of the hollow tubular composite axle at the power output end; and
a power output double stub end having a first end secured to the inner race of the power output bearing and a second end protruding from the power output end of the hollow tubular axle.

8. The composite half shalt of claim 7 further comprising a flexible rubber boot, the rubber boot being attached at a first end around the power input end of the tubular composite axle or constant velocity joint and at the second end around the power input double stub end.

9. The composite half shaft of claim 7 wherein at least one of the power input constant velocity joint or power output constant velocity joint is press fit into the inner wall of the hollow tubular composite axle.

10. The composite half shaft of claim 7 wherein at least one of the power input constant velocity joint or the power output constant velocity joint is secured to the inner wall of the hollow tubular composite axle with an adhesive.

11. The composite half shaft of claim 7 wherein each of the power input constant velocity joint and the power output constant velocity joints are situated within the inner wall of the hollow tubular composite axle.

12. The composite half shaft of claim 7 wherein the constant velocity joint is a tripod joint.
